(19) United States
(12) Patent Application Publication
(10) Pub. No.: US 2005/0151471 A1
(43) Pub. Date: Jul. 14, 2005

(54) Light emitting apparatus and extra-high pressure mercury lamp therefor

(75) Inventor: Akihisa Morimoto, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA

(21) Appl. No.: 11/030,206

(22) Filed: Jan. 7, 2005

(30) Foreign Application Priority Data
Jan. 9, 2004 (JP) 2004-004800

(51) Int. Cl. H01J 61/04; H01J 17/04

(52) U.S. Cl. 313/575; 313/633; 313/491

(57) ABSTRACT

An object of the present invention is attained by an extra-high pressure mercury lamp comprising a cathode made of tungsten, a cathode, a discharge container, wherein the cathode and the cathode are arranged so as to face each other in the discharge container made of quartz glass, and 0.16 mg/mm³ or more mercury, rare gas, and halogen are enclosed in the discharge container, the extra-high pressure mercury lamp, and wherein the cathode is made of 4N (99.99%) purity or more tungsten, wherein, while UV light with high brightness can be emitted from the lamp, it is possible to realize high UV light output stability which is higher than that of the conventional extra-high pressure mercury lamp, in terms of UV light intensity retention ratio or a UV light intensity change ratio.

### FIELD OF THE INVENTION

The present invention relates to a light emitting apparatus using an extra-high pressure mercury lamp and an extra-high pressure mercury lamp therefore, in particular, to a light emitting apparatus using an extra-high pressure mercury lamp and an extra-high pressure mercury lamp therefore which may be used for a UV (ultraviolet rays) irradiation type semiconductor inspection apparatus used for an appearance inspection process of a semiconductor wafer.

### DESCRIPTION OF THE RELATED ART

Conventionally, an extra-high pressure mercury lamp in which the amount of mercury enclosed in a discharge container is 0.10 mg/mm³ or less, and the output is approximately 100 W, is used as a UV light source of the UV light emission type semiconductor inspection apparatus, as well as a lamp used for exposure of semiconductor circuit patterns.

During lighting, the mercury enclosed in the discharge container evaporates, and the mercury vapor pressure of the lamp is approximately several millions Pa (tens atmospheric pressure).

Moreover, such an extra-high pressure mercury lamp has intense light emission in the ultraviolet region (350 nm-450 nm) including a bright line spectrum peculiar to mercury, and especially has high intensity monochromatic light (365 nm etc.).

Japanese Laid Open Patent No. 2001-338502 discloses that a mercury lamp is used for semiconductor inspection.

### SUMMARY OF THE INVENTION

In order to inspect very detailed portions, such as a resist pattern etc. applied to a semiconductor, by UV light emitted from a lamp, a semiconductor inspection apparatus which has high resolution characteristic is required, that is, an extra-high pressure mercury lamp having a high intensity characteristic is necessary.

Furthermore, in recent years, highly integrated semiconductor devices have been developed, so that the brightness of UV light runs short at several hundreds Pa (tens times of atmospheric pressure) of the mercury vapor pressure at time of lighting of the conventional extra-high pressure mercury lamp.

Then, when higher power is merely applied to the conventional extra-high pressure mercury lamp in order to increase the brightness, a load to electrodes become large and there is a problem that the electrode is melt so that the life span thereof is shortened.

Moreover, in order to inspect the detailed circuit pattern of a semiconductor with sufficient accuracy, in addition to emission of UV light with high brightness, output stability which is higher than that in a conventional extra high pressure mercury lamp in which the amount of mercury is 0.10 mg/mm³ or less, is required.

In view of the above-mentioned various problems, it is an object of the invention to provide a high pressure mercury lamp having high UV output stability which is higher than that of the conventional high pressure mercury lamp in addition to ability to emit high brightness UV light.

Moreover, it is another object of the present invention to provide a light emitting apparatus using a high pressure mercury lamp having high UV light output stability which is higher than that of the conventional high pressure mercury lamp in addition to ability to emit high brightness UV light.

The object of the present invention is attained by an extra-high pressure mercury lamp comprising a cathode made of tungsten, a cathode, a discharge container, wherein the cathode and the cathode are arranged so as to face each other in the discharge container made of quartz glass, and 0.16 mg/mm³ or more mercury, rare gas, and halogen are enclosed in the discharge container, the extra-high pressure mercury lamp, and wherein the cathode is made of 4N (99.99%) purity or more tungsten, wherein, while UV light with high brightness can be emitted from the lamp, it is possible to realize high UV light output stability which is higher than that of the conventional extra-high pressure mercury lamp, in terms of UV light intensity retention ratio or a UV light intensity change ratio.

In the extra-high pressure mercury oxygen may be enclosed in the discharge lamp and the amount of the oxygen is 0.05 to 0.45% to rare gas enclosure gas pressure. Thus, if the discharge container contains oxygen whose amount is 0.05 to 0.45% to rare gas enclosure pressure, it is possible to very effectively prevent blackening of an inner wall of the discharge lamp.

In the extra-high pressure mercury lamp, the extra-high pressure mercury lamp may be turned on according to constant current control. Thus, if the extra-high pressure mercury lamp is turned on according to a constant current control, it is possible to achieve high UV light output stability which is higher than that of the conventional extra-high pressure mercury lamp in terms of UV light intensity retention ratio or a UV light intensity change ratio.

The object of the present invention may be attained by a light emitting apparatus comprising, an extra-high pressure mercury lamp having a cathode made of tungsten, a cathode, a discharge container, wherein the cathode and the cathode are arranged so as to face each other in the discharge container made of quartz glass, and 0.16 mg/mm³ or more mercury, rare gas, and halogen are enclosed in the discharge container, the extra-high pressure mercury lamp, and wherein the cathode is made of 4N (99.99%) purity or more tungsten, and a light switching unit, in which ultraviolet light or visible light in light emitted from the extra-high pressure mercury lamp passes through the light switching unit. Thus, if in addition to the light emitted from the above-mentioned extra-high pressure mercury lamp, a light switching unit is provided in the light source apparatus, it is possible to carry out inspection by white light and inspection by UV light, using one extra-high pressure mercury lamp.

In the light emitting, the light switching unit may be a band pass filter.

### BRIEF DESCRIPTION OF THE DRAWINGS

FIG. 1 is a schematic overview of an extra-high pressure mercury lamp according to embodiments of the present invention;

FIG. 2 shows a measurement result of UV light intensity retention ratio (%) and UV light intensity retention change (%) in case that the extra-high pressure mercury lamp according to the present invention is turned on for one hour;

FIG. 3 shows a measurement result of UV intensity retention ratio and the UV light change ratio in case that a comparative extra-high pressure mercury lamp was turned on for one hour, in order to draw contrast between the extra-high pressure mercury lamp according to the present invention and that of the comparative example;

FIG. 4 shows a table showing the relation between a degree of blackening and a UV light intensity change ratio in case that the amount of oxygen as filler gas is changed;

FIG. 5 shows a measurement result of a UV light intensity retention ratio and a UV light change ratio in case that the extra-high pressure mercury lamp according to the embodiment of the present invention is turned on for one hour;

FIG. 6A shows a measurement result of a UV light intensity retention ratio of the extra-high pressure mercury lamp according to the embodiment of the present invention and that of the comparative example, which were measured after a lapse of 0 to 500 hours when these lamps were turned on by a constant power power supply (150 W) and a constant current power supply (2 A), respectively;

FIG. 6B shows a measurement result of a UV light intensity change ratio of the extra-high pressure mercury lamp according to the embodiment of the present invention and that of the comparative example, which were measured after a lapse of 0 to 500 hours when these lamps were turned on by a constant power power supply (150 W) and a constant current power supply (2 A), respectively; and

FIG. 7 is a schematic view of a wafer inspection apparatus having a light emitting apparatus in which an extra-high pressure mercury lamp according to the present invention is built in.

### DESCRIPTION OF THE PREFERRED EMBODIMENTS

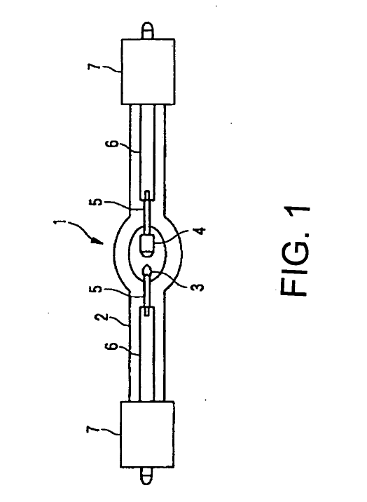

Description of a first embodiment according to the present invention, will be given, referring to FIGS. 1-3.

FIG. 1 is a schematic overview of an extra-high pressure mercury lamp according to the embodiment of the present invention.

In FIG. 1, an extra-high pressure mercury lamp 1 has a discharge container made of quartz glass, a cathode 3 made of material including 4N (99.99%) purity percent tungsten and 5 wt. ppm or less of potassium (K), an anode 4 made of tungsten, lead rods 5, 5 connected to the cathode 3 and the anode 4 respectively, metallic foils 6, 6 connected to the lead rods 5, 5, respectively, and mouth pieces 7.7.

As shown in this figure, in the extra-high pressure mercury lamp 1, the cathode 3 and the anode 4 are arranged so as to face each other in the discharge container 2, wherein 0.16 mg/mm³ mercury and 2×10⁻⁴−7×10⁻2 μmol/mm³ halogen are enclosed, and further, argon (Ar) and bromine (Br) which are rare gas, are enclosed as filler gas.

In addition, as for the halogen, for example, 1×10⁻⁷−1×10⁻² μmol/mm³ bromine (Br) is enclosed.

In place of the conventional extra-high pressure mercury lamp for forming a semiconductor circuit patterns, wherein the amount of mercury enclosed is less than 0.10 mg/mm³ and rare gas was enclosed, in the present invention, attention is paid to an extra-high pressure mercury lamp in which 0.16 mg/mm³ or more mercury, rare gas, and a certain amount of halogen are enclosed.

Since the extra-high pressure mercury lamp emits high intensity white light of a continuous visible range, it is conventionally used as a light sources for projection, such as a liquid crystal projector. However, it possible to use the extra-high pressure mercury lamp which has been used as such a conventional lamp using only the visible light, as a lamp which emits UV light by selecting electrode materials, filler gas, and lighting condition etc.

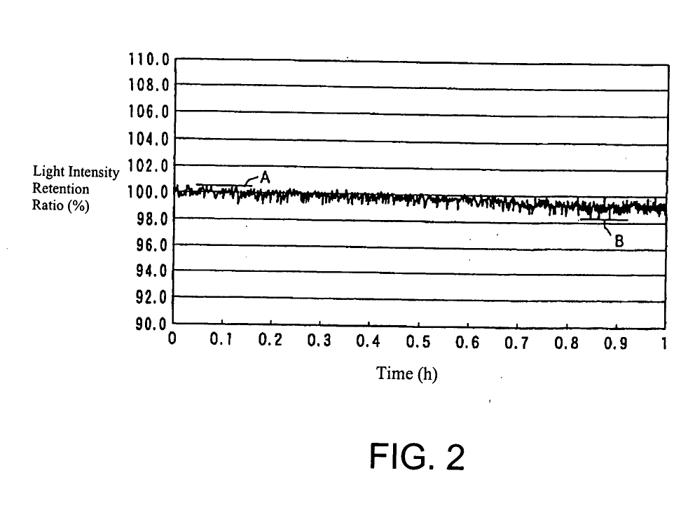

FIG. 2 shows a measurement result of a UV light intensity retention ratio (%) and a UV light intensity change ratio (%) in case that the extra-high pressure mercury lamp according to the present invention was turned on for one hour.

The extra-high pressure mercury lamp according to the present invention has, as mentioned above, the cathode 3 which is made of material including at least, 4 N (99.99%) purity percent of tungsten, and 5 wt. ppm potassium (K).

As to the lighting conditions, a constant power power supply (150 W) was used, and in the measurement, an arc portion of the extra-high pressure mercury lamp was enlarged and projected through a quartz lens, and a photo acceptance unit of a UV Illuminometer was arranged to the arc portion where the arc was projected, wherein light having wavelength of 365 nm was measured.

The “UV light intensity ratio” means a relative value (%) of UV light intensity which changes with time progress when setting UV light intensity at the time of a lighting initiation to 100, and the “UV light intensity change ratio” means difference (%) of the maximum value (A) of the UV light intensity retention ratio and the minimum value (B) thereof in one hour period after the lighting is initiated.

Moreover, the time for measuring was set to one (1) hour because the time taken to inspect one semiconductor wafer was about one (1) hour.

In FIG. 2, the UV light intensity retention ratio of the extra-high pressure mercury lamp according to the present invention is shown, and the UV intensity change ratio was 2.1%.

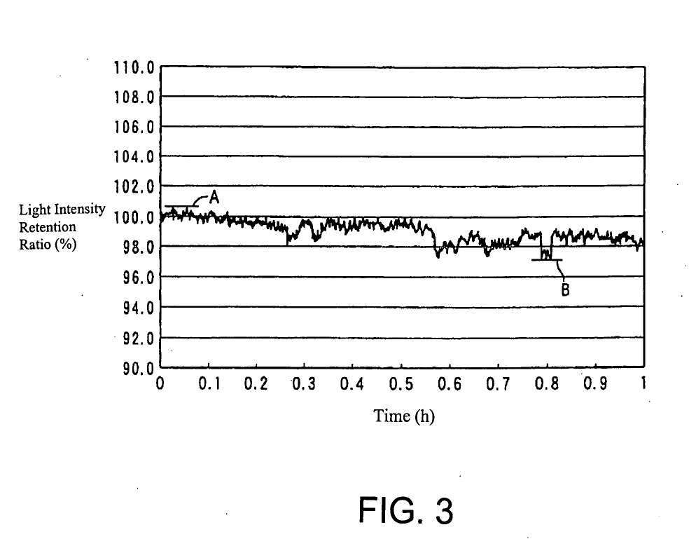

FIG. 3 shows a measurement result of UV intensity retention ratio and the UV light change ratio at time in case that a comparative extra-high pressure mercury lamp was turned on for one hour, in order to draw contrast between the extra-high pressure mercury lamp according to the present invention and that of the comparative example.

As the comparative extra-high pressure mercury lamp, the conventional extra-high pressure mercury lamp for a white light source of a liquid projector is used, wherein a cathode made of material including 99.96% purity percent tungsten, and 40-75 wt. ppm potassium (K), was provided.

In FIG. 3, the UV light intensity retention ratio of the comparative extra-high pressure mercury lamp is shown, and the UV light intensity change ratio thereof was 3.6%.

When the extra-high pressure mercury lamp according to the present invention and the comparative extra-high pressure mercury lamp are compared with each other, as seen in FIGS. 2 and 3, alghough the UV light intensity retention ratio of the comparative extra-high pressure lamp decreased to approximately 98% one hour after the lighting initiation, that of the extra-high pressure mercury lamp according to the present invention was maintained to 99% or more.

Moreover, the UV light intensity change ratio of the extra-high pressure mercury lamp according to the present invention is also sharply improved with 2.1%, although that of the comparative extra-high pressure mercury lamp was 3.6%.

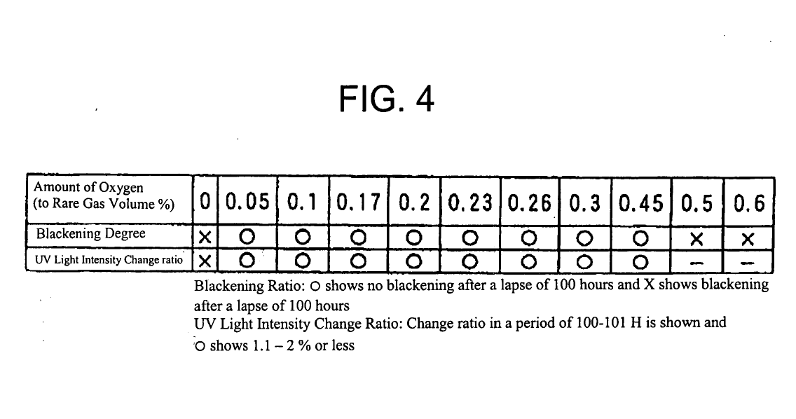

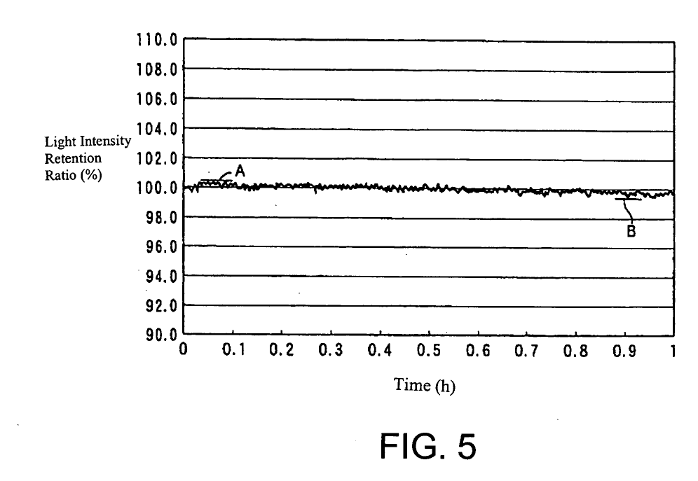

Next, a second embodiment according to the present invention will be described referring to FIGS. 4 and 5.

Although the structure of the extra-high pressure mercury lamp according to the second embodiment of the present invention is the same as that shown in FIG. 1, the lamp of the second embodiment is different compared with the extra-high pressure mercury lamp according to the first embodiment of the present invention at a point that oxygen (O) whose amount is (corresponds to) 0.05-0.45 volume % to rare gas-charged pressure is added as filler gas in the discharge container 2.

The Oxygen was used as gas enclosed in the discharge container since the oxygen has the effect that it raises, in the wall of the discharge container, the vapor pressure of tungsten compound which adheres to the wall thereby causing blackening.

FIG. 4 shows a table showing the relation between a degree of blackening and a UV light intensity change ratio in case that the amount of oxygen as filler gas is changed.

Here, the measurement was carried out at the lighting conditions where a constant power power supply (150 W) was used and the lamp was turned on, arranging it horizontally.

As shown in FIG. 4, when 0.05-0.45 volume % of oxygen to rare gas-charging pressure was enclosed, the UV light intensity change ratio was settled to less than 1.1-2% even after a lapse of 100 hours, and further the blackening was not recognized after the lapse of 100 hours.

This is because halogen cycle was activated in the discharge container.

FIG. 5 shows a measurement result of a UV light intensity retention ratio and a UV light change ratio in case that the extra-high pressure mercury lamp according to the embodiment of the present invention was turned on for one hour.

In this measurement, oxygen whose amount is (corresponds to) 0.2 volume % to rare gas-charging pressure is added as filler gas in the discharge container 2. FIG. 5 shows the UV light retention ratio of the extra-high pressure mercury lamp according to the second embodiment and the UV light change ratio thereof was 1.1%.

When the extra-high pressure mercury lamp according to the first embodiment of the present invention and that of the second embodiment are contrasted, as seen in FIGS. 2 and 5, although the UV light intensity retention ratio of the first embodiment was secured to 99% or more for one hour after the lighting initiation, that of the second embodiment was secured to 99.5% or more.

Moreover, while the UV light intensity change ratio of the extra-high pressure mercury lamp according to the first embodiment was 2.1%, that of the second embodiment was improved to 1.1%.

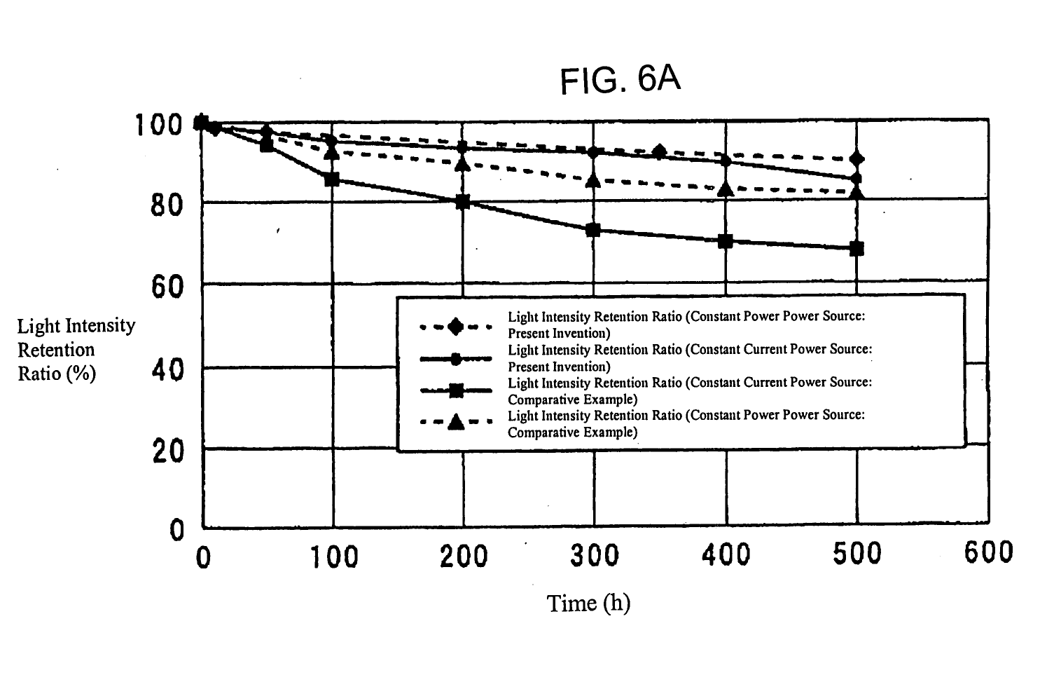

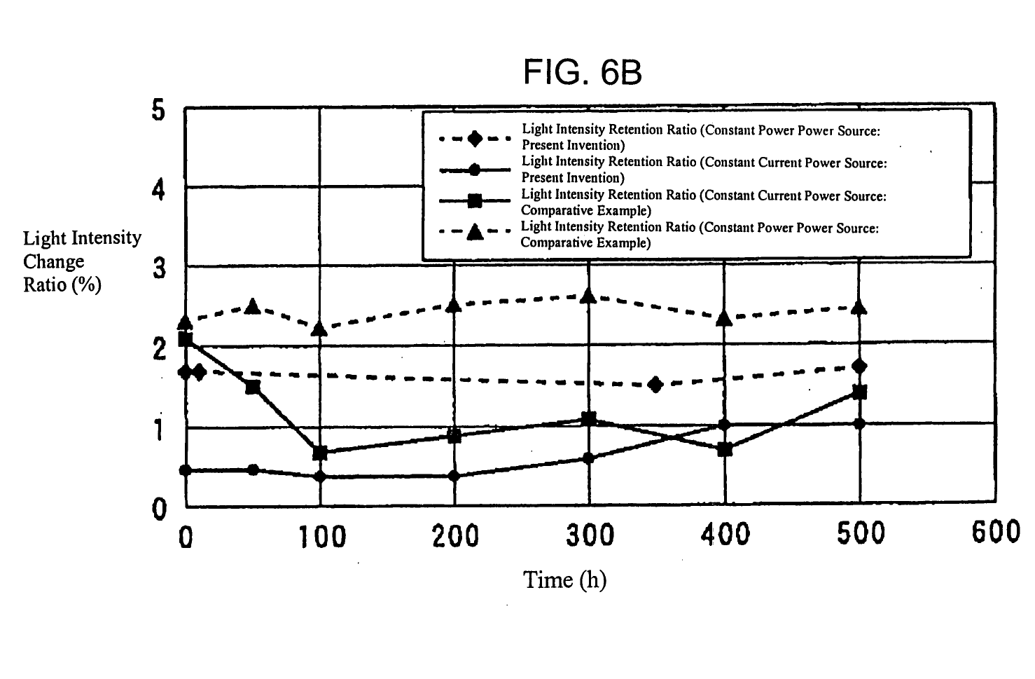

Next, description of a third embodiment will be give below referring to FIGS. 6A and 6B.

Although the structure of the extra-high pressure mercury lamp according to the third embodiment of the present invention is the same as that shown in FIG. 1, the lamp of the third embodiment was turned on by constant current power supply while the lamp of the first embodiment was turned on by constant power power supply.

In addition, the comparative lamp used for the following measurement was the same as that used in the first embodiment of the present invention.

FIG. 6A shows a measurement result of a UV light intensity retention ratio of the extra-high pressure mercury lamp according to this embodiment of the present invention and that of the comparative example, which were measured after a lapse of 0 to 500 hours when these lamps were turned on by a constant power power supply (150 W) and a constant current power supply (2 A), respectively.

FIG. 6B shows a measurement result of a UV light intensity change ratio of the extra-high pressure mercury lamp according to this embodiment of the present invention and that of the comparative example, which were measured after a lapse of 0 to 500 hours when these lamps were turned on by a constant power power supply (150 W) and a constant current power supply (2 A), respectively.

The “UV light intensity ratio” means a relative value (%) of UV intensity which changes with time progress when setting UV light intensity at the time of a lighting initiation to 100, and “UV light intensity change ratio” means the difference (%) of the maximum value of the UV light intensity retention ratio and the minimum value during one hour period after a laps of a certain time (for example, a lapse of 100 hours), that is, a period from a lapse of 100 hours to a laps of 101 hours.

As shown in FIG. 6A, even when the extra-high pressure mercury lamp according to the present invention was turned by the constant power power supply or the constant current power supply, the UV light intensity retention ratio of the extra high pressure mercury lamp according to the present invention was improved as compared with that of the comparative extra-high pressure mercury lamp.

In addition, in the figure, compared with the case where the lamp was turned on with the constant power power supply, the UV light intensity retention ratio of the lamp which was turned on by the constant current power supply is relatively low. It is deemed that much of the electrode is consumed in case of using the constant current power supply.

Moreover, as shown in FIG. 6B, when the lamp was turned on by using the constant current power supply, the UV light intensity change ratio becomes 1% or less, and thus, the UV light intensity change ratio of the extra-high pressure mercury lamp according to the present invention was improved sharply, compared with the case where the light was turned on by using the constant power power supply.

Moreover, even when the comparative extra-high pressure mercury lamp was turned on by using the constant current power supply, the UV light intensity change ratio thereof was improved much more than the case where the extra-high pressure mercury lamp according to the present invention was turned on by using the constant power power supply.

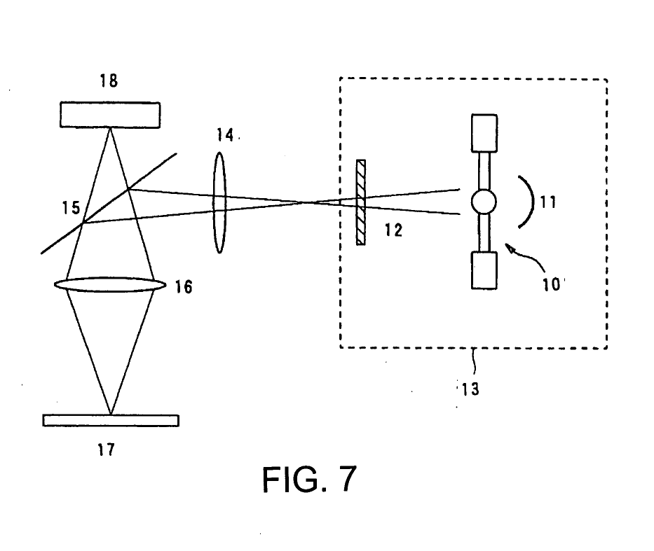

Next, a fourth embodiment of the present invention is explained using FIG. 7.

FIG. 7 is a schematic view of a wafer inspection apparatus having a light emitting apparatus in which an extra-high pressure mercury lamp according to the present invention is built in.

In the figure, an extra-high pressure mercury lamp 10 which is the same as the extra-high mercury lamp according to the above-mentioned first to third embodiments of the present invention, emits light, and the light from the lamp 10 is reflected and condensed by a reflecting mirror 11.

On the optical path on which the condensed light passes and reaches to a relay lens 14, a light switching unit 12 comprising, for example, a band pass filter etc. is disposed.

The light emitting apparatus 13 comprises at least the high pressure mercury lamp 10, the reflecting mirror 11 and the light switching unit 12.

The light switching unit 12 has a function for passing either UV light or visible light among the light emitted from the extra-high pressure mercury lamp 10 by a switching operation.

After the UV light or visible light which passes through the light switching unit 12, the light passes through the relay lens 14, and is incident to an objective lens 16 through a half mirror 15, and then is irradiated to a wafer 17.

The optical image on a wafer 17 is projected on an image sensor 18 through the objective lens 16 and the half mirror 15.

In the conventional method as described in Japanese Laid Open Patent No. 2001-338502, two (2) rays of light, that is, white light and UV light are necessary. However, by using the light emitting apparatus according to the present invention wherein the extra-high mercury lamp 10 is used together with the light switching unit 12, inspection by white light and inspection by UV light can be carried out by using only one extra-high pressure mercury lamp.

Thus the present invention possesses a number of advantages or purposes, and there is no requirement that every claim directed to that invention be limited to encompass all of them.

The disclosure of Japanese Patent Application No. 2004-004800 filed on Jan. 9, 2004 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. An extra-high pressure mercury lamp comprising:
a cathode made of tungsten;
a cathode;
a discharge container, wherein the cathode and the cathode are arranged so as to face each other in the discharge container made of quartz glass, and 0.16 mg/mm³ or more mercury, rare gas, and halogen are enclosed in the discharge container, the extra-high pressure mercury lamp, and
wherein the cathode is made of 4N (99.99%) purity or more tungsten.

2. The extra-high pressure mercury lamp according to claim 1, wherein oxygen is enclosed in the discharge lamp and the amount of the oxygen is 0.05 to 0.45% to rare gas enclosure gas pressure.

3. The extra-high pressure mercury lamp according to claim 1, wherein the extra-high pressure mercury lamp is turned on according to constant current control.

4. The extra-high pressure mercury lamp according to claim 2, wherein the extra-high pressure mercury lamp is turned on according to constant current control.

5. A light emitting apparatus comprising:
an extra-high pressure mercury lamp having a cathode made of tungsten, a cathode, a discharge container, wherein the cathode and the cathode are arranged so as to face each other in the discharge container made of quartz glass, and 0.16 mg/mm³ or more mercury, rare gas, and halogen are enclosed in the discharge container, the extra-high pressure mercury lamp, and wherein the cathode is made of 4N (99.99%) purity or more tungsten; and
a light switching unit, in which ultraviolet light or visible light in light emitted from the extra-high pressure mercury lamp passes through the light switching unit.

6. The light emitting apparatus according to claim 5, wherein oxygen is enclosed in the discharge lamp and the amount of the oxygen is 0.05 to 0.45% to rare gas enclosure gas pressure.

7. The light emitting apparatus according to claim 5, wherein the extra-high pressure mercury lamp is turned on according to constant current control.

8. The light emitting apparatus according to claim 6, wherein the extra-high pressure mercury lamp is turned on according to constant current control.

9. The light emitting apparatus according to claim 5, wherein the light switching unit is a band pass filter.
